(19) United States
(12) Patent Application Publication
(10) Pub. No.: US 2008/0248228 A1
(43) Pub. Date: Oct. 9, 2008

(54) PRODUCE PACKAGING

(75) Inventors: Norman Dorien Joseph Aubee, Okotoks (CA); Jamie Michael Marler, Calgary (CA); Daniel Rowan Ward, Maineville, OH (US)

Correspondence Address: James R. Franks, NOVA Chemicals Inc., 1550 Coraopolis Heights Road, Moon Township, PA, 15108, US

(73) Assignee: NOVA CHEMICALS (INTERNATIONAL) S.A., Fribourg (CH)

(21) Appl. No.: 12/048,458

(22) Filed: Mar. 14, 2008

Related U.S. Application Data
(60) Provisional application No. 60/921,793, filed on Apr. 4, 2007.

(51) Int. Cl. B32B 27/08

(52) U.S. Cl. 428/35.7

(57) ABSTRACT

Disclosed is a produce package made from a gas permeable, non-perforated polyethylene film. The polyethylene film is made from a blend of a linear low density polyethylene and a high pressure low density polyethylene. The film has an absolute oxygen transmission rate that is greater than the weighted average of the absolute oxygen transmissions rates for film made from each blend component. Disclosed are polyethylene blends having densities above 0.910 g/cc that can be made into films with absolute oxygen transmission rates greater than 550 ccO₂.mil/100 in2.24 hrs.

### CROSS REFERENCE TO RELATED PATENT APPLICATION

The present non-provisional patent application is entitled to and claims, under 35 U.S.C. §119(e), the benefit of U.S. Provisional Patent Application No. 60/921,793, filed Apr. 4, 2007, which is hereby incorporated herein in its entirety by reference.

### FIELD OF INVENTION

The current invention is directed to polyethylene film suitable for use in produce packaging. Films having unusually high oxygen transmission rates at densities above 0.910 g/cc are reported.

### BACKGROUND OF THE INVENTION

The fresh produce market generally includes products such as lettuce or premixed salads, broccoli, cabbage, carrots and the like. These types of foodstuffs continue to respire after being picked. As a result, use of packaging that has high oxygen and carbon dioxide transmission rates is required to allow respiration to continue and to maintain produce freshness. Hence, for application in fresh cut produce packaging, polyethylene film must offer oxygen transmission rates high enough to ensure that the package achieves the desired breathability for the specific food stuff being packaged.

Several methods for making “breathable” polyethylene films have been developed including microperforation, the incorporation of filler materials into stretched film to generate voids in the polymer film, the use of multilayer film structures having gas permeable layers and the use of gas permeable polymer blends.

For example, U.S. Pat. No. 4,472,328 discloses a process for producing a gas permeable film by compounding a linear low density (LLDPE) polyolefin with at least one filler selected from the group consisting of inorganic fillers and cellulose type organic fillers. Fillers such as calcium carbonate, talc, clay, silica, diatomaceous earth and barium sulfate are preferred. When the film is stretched, as, for example, in mono or biaxial orientation, the fillers generate voids in the polymer film that provide gas permeability.

U.S. Pat. No. 6,319,975 teaches the addition of inorganic fillers such as calcium carbonate and polypropylene to linear low density polyethylene in order to prepare films having increased air permeability with good processability.

U.S. Pat. No. 6,579,607 discloses polyolefin film with controlled permeability by incorporating non-porous inert filler such as glass microspheres into film comprising linear low density polyethylene.

Alternatively, U.S. Patent Application Publication No. 2004/0191476 describes a method in which microperforated polymer is generated by physically punching holes in a packaging material. Various methods such as cold or hot needle mechanical punches, electrical spark microperforation, and laser perforation can be used. The microperforated film is used in multilayer structures.

Several U.S. patents provide multilayer film structures in which gas permeable layers are combined with layers that impart desired physical or mechanical properties such as melt strength.

For example, U.S. Pat. No. 5,491,019 discloses a multilayer film comprising outer layers made from an ethylene plastomer (where the plastomer has a density, d as defined by grams per cubic centimeter of 0.90 g/cc) and an inner layer preferably composed of polypropylene (PP) or a propylene/ethylene copolymer. The outer layers provide gas permeability while the core layers provide mechanical strength. Oxygen transmission rates as high as 7691 cubic centimeters per square meter per day, cc/m2/24 hrs were measured for tri-layer structures having linear low density polyethylene as the outside layers and polypropylene as the core layer. Related oxygen permeable, multi-layer film structures are disclosed in U.S. Pat. Nos. 6,294,210, 6,060,136 and 5,962,092.

For fresh cut produce having a high rate of transpiration such as broccoli and asparagus, an oxygen transmission rate of at least 1000 ccO2/100 in2.24 hours is desirable and is most commonly achieved using films comprising plastomers. However, polyethylene having a density below about 0.912 g/cc can be difficult to process due to poor melt-strength, film blocking and high extruder pressures.

Polymer blends involving the combination of a very low density polyethylene (i.e., a plastomer) with polypropylene are known to have good gas permeability and processability. For example, U.S. Pat. No. 6,086,967 discloses a polymer blend comprising 80-95 weight per cent of at least one homogeneous, very low density ethylene polymer (d=0.89 to 0.90 g/cc) and 5 to 20 weight per cent of at least one polypropylene polymer. Film structures were made which show an oxygen transmission rate of at least 700 ccO2.mil/100 in2.24 hrs at standard temperature and pressure.

Although, blends of linear low density polyethylene (LLDPE) or very low density polyethylene (VLDPE) with high pressure low density polyethylene are well known, the use of such blends to improve oxygen and vapor transmission rates in produce packaging has not previously been taught. For example, U.S. Pat. Nos. 5,721,025; 5,288,531; 5,942,579 and 6,117,465 disclose films made from a blend of a linear low density polyethylene with high pressure low density polyethylene. The films are applied to packaging applications for flowable materials such as a pouch for packaging milk, water, juice and other liquids. There is no teaching of films having high oxygen transmission rates as required for application in produce packaging.

### SUMMARY OF INVENTION

The present invention overcomes the processing problems typically associated with resins having very high oxygen transmission rates, by providing a non-perforated polyethylene film prepared from polymer blends comprising a linear low density polyethylene having a density of greater than 0.905 g/cc and a high pressure low density polyethylene having a density of at least 0.916 g/cc. Thus, the present invention provides a polyethylene film having an improved balance of oxygen transmission rate and density for use in packaging for respiring produce.

One aspect of the present invention is a sealed produce package made from a gas permeable, non-perforated polyethylene film, wherein said film is prepared from a polymer blend comprising: (a) 95-70 wt % of a linear low density polyethylene having a density of from 0.905 to 0.920 g/cc; and (b) 5 to 30 wt % of a high pressure low density polyethylene having a melt index, I₂, of from 0.15 to 2.0 g/10 min.

Another aspect of the invention provides a sealed produce package made from a gas permeable, non-perforated polyethylene film prepared from a polymer blend comprising: (a) 95-70 wt % of a linear low density polyethylene having a melt index, I₂, of from 0.5 to 2.0 g/10 min, and (b) 5 to 30 wt % of a high pressure low density polyethylene having a melt index, I₂, of from 0.15 to 2.0 g/10 min, and a density of from 0.916 to 0.924 g/cc; wherein the linear low density polyethylene is a heterogeneously branched polyethylene having a density greater than 0.916 g/cc and a molecular weight distribution, Mw/Mn of less than 4.0.

Another aspect of the present invention is a sealed produce package made from a gas permeable polyethylene film prepared from a polymer blend comprising a linear low density polyethylene component and a high pressure low density polyethylene component, wherein the gas permeable polyethylene film has an absolute oxygen transmission rate which is greater than the weighted average of the absolute oxygen transmission rates of film prepared from each blend component.

In yet another aspect, the invention provides a sealed produce package made from a gas permeable polyethylene film having an absolute oxygen transmission rate of greater than 550 ccO2 at 1 mil/100 in2.24 hrs, wherein the film is prepared from a polymer blend having a density of at least 0.910 g/cc.

The invention also provides a sealed produce package made from a multilayer film comprising: i) one or more than one layer of a gas permeable, non-perforated polyethylene film prepared from a polymer blend comprising: (a) 95-70 wt % of a linear low density polyethylene having a density of from 0.905 to 0.920 g/cc; and (b) 5 to 30 wt % of a high pressure low density polyethylene having a melt index, I₂, of from 0.15 to 2.0 g/10 min; and ii) one or more than one polyolefin film layer.

Provided is a gas permeable, non-perforated polyethylene film for use in a sealed produce package, wherein said film is prepared on a blown film line, said film comprising a blend comprising: (a) 95-70 wt % of a linear low density polyethylene having a density of from 0.905 to 0.920 g/cc; and (b) 5 to 30 wt % of a high pressure low density polyethylene having a melt index, I₂, of from 0.15 to 2.0 g/10 min; wherein the normalized OTR of said film increases as the drawdown ratio of said blown film line is increased.

Also provided is a process for making film on a blown film line, said process comprising increasing the drawdown ratio from a first lower drawdown ratio to a second higher drawdown ratio, wherein the increase in drawdown ratio increases the normalized OTR of said film, said film comprising a blend of: (a) 95-70 wt % of a linear low density polyethylene having a density of from 0.905 to 0.920 g/cc; and (b) 5 to 30 wt % of a high pressure low density polyethylene having a melt index, I₂, of from 0.15 to 2.0 g/10 min; wherein said film is for use in a sealed produce package.

### DETAILED DESCRIPTION OF THE INVENTION

The current invention is directed to film compositions having a high oxygen transmission rate (OTR) for use in fresh cut produce packaging.

Several related units of measure are used in the literature to measure the oxygen transmission rate (OTR) of films, including ccO2/m2.24 hrs or ccO2/100 in2.24 hrs at standard temperature and pressure (STP) as described in ASTM D3985-81. In ASTM D3985-81, the thickness of the film tested is not included in the units for expressing the OTR.

The oxygen transmission rate can also be expressed as cubic centimeters (cc) of oxygen (O2), per 100 square inches of the film (100 in2), per 24 hr period, per mil of film thickness (i.e. ccO2.mil/100 in2.24 hrs). This is a normalized oxygen transmission rate as measured for a film of any thickness but reported per mil of film thickness (i.e. normalized OTR=OTR×thickness of the film in mil).

In the current invention, the term “absolute oxygen transmission rate” refers to the OTR (ccO2/100 in2.24 hrs) measured under standard conditions (1 atm, 23° C.) for a film having an actual film thickness of 1 mil (1 mil=0.001 inch) and is expressed as ccO2 at 1 mil/100 in2.24 hrs. Without wishing to be bound by theory, the absolute oxygen transmission rate should be close to, but not necessarily equal to the normalized OTR measured for a film having any thickness but reported per mil of film thickness.

By the term “package”, it is meant that the film is formed into a sealed enclosure that contains produce. The term “produce” is meant to include fresh foodstuffs that respire or which deteriorate in the absence of oxygen/carbon dioxide gas exchange. Typical examples include lettuce, broccoli, beans, cabbage, celery, tomatoes, leeks, spinach, asparagus and the like. The produce may be whole or cut, as for example in freshly cut lettuce. The listed produce items are not meant to be limiting and serve only as examples of food stuffs that respire. The phrase “sealed produce package” then, connotes a sealed package that contains respirating produce.

By the term “gas permeable”, it is meant that the film is permeable to oxygen, carbon dioxide and nitrogen.

The films of the current invention are not perforated or microperforated (i.e., they have no pores or micropores).

The gas permeable, non-perforated polyethylene film of the current invention may be made either by blown film or cast film extrusion techniques, both of which are well known in the art. Blown film extrusion and cast films extrusion methods are described in “Films, Manufacture” by Eldridge M. Mount, published online: 22 Oct. 2001 in Encyclopedia Of Polymer Science and Technology, pg 283, © 2002 by John Wiley & Sons, Inc., last updated: 19 Sep. 2006.

The films used in the current invention are made from a polymer blend of a linear low density polyethylene (LLDPE) and a high pressure, low density polyethylene (HPLDPE), both of which are well known in the art.

One component of the polymer blends for use in the current invention is a linear low density polyethylene (LLDPE). In the current invention, “linear low density polyethylene” is a copolymer or terpolymer of ethylene and one or more than one comonomer. The comonomers can be selected from C₃-C₂₀ alpha olefins and/or C₄-C₁₈ diolefins. Copolymers of propylene, 1-butene, 1-hexene, 4-methyl-1-pentene and 1-octene are preferred.

The LLDPE of the current invention can be a homogeneously branched or heterogeneously branched linear ethylene copolymer or linear polyethylene. In the current invention, the phrases “homogeneously branched ethylene copolymer” and “homogeneously branched polyethylene” are used interchangeable as are the phrases “heterogeneously branched ethylene copolymer” and “heterogeneously branched polyethylene”.

The term “homogeneously branched polymer” is defined in U.S. Pat. No. 3,645,992. Accordingly, homogeneously branched polyethylene is a polymer that has a narrow composition distribution. That is, the comonomer is randomly distributed within a given polymer chain and substantially all of the polymer chains have same ethylene/comonomer ratio. The composition distribution of a polymer can be characterized by the short chain distribution index (SCDI) or composition distribution breadth index (CDBI). The CDBI is defined as the weight per cent of the polymer molecules having a comonomer content within 50 per cent of the median total molar comonomer content. The CDBI is determined using techniques well known in the art, particularly temperature rising elution fractionation (TREF) as described in Wild et al, Journal of Polymer Science, Pol. Phys. Ed. Vol 20, p 441 (1982) or in U.S. Pat. No. 4,798,081.

For the present invention, homogeneously branched polyethylene will have a CDBI of greater than about 30%, more preferably of greater than about 50%.

The homogeneously branched polyethylene can be prepared using any catalyst capable of producing homogeneous branching. The preferred catalysts will be based on a group 4 metal having at least one cyclopentadienyl ligand that are well known in the art. Examples of such catalysts are described in U.S. Pat. Nos. 3,645,992; 5,324,800; 5,064,802; 5,055,438; 6,689,847; 6,114,481 and 6,063,879. Such catalysts may also be referred to as “single site catalysts” to distinguish them from traditional Ziegler-Natta catalysts which are also well known in the art.

In an aspect of the current invention, homogeneously branched polyethylene is prepared using an organometallic complex of a group 3, 4 or 5 metal that is further characterized as having a phosphinimide or a ketimide ligand.

The term “heterogeneously branched polyethylene” is meant to describe linear ethylene copolymer having a relatively low, short chain distribution index or comonomer distribution breadth index compared to homogeneously branched polyethylene. More specifically, a heterogeneously branched polymer preferably has a short chain distribution index, SCDI of less than 30%. In addition, the heterogeneously branched polymer preferably has at least 10 wt % of a homopolymer component (i.e., a component having less than one short chain branch per 1000 carbon atoms). The heterogeneously branched polyethylenes of the current invention are preferably produced using traditional Ziegler-Natta type catalysts that are well known in the art.

The other component of the polymer blends described by the current invention is a high pressure low density polyethylene (HPLDPE). HPLDPE is prepared by homopolymerization of ethylene under high pressures in the presence of a radical initiator. HPLDPE contains long chain branching, which provide favorable rheological properties for use in extrusion processes such as those used to produce film. HPLDPE is well known in the art and is widely available.

The preparation of HPLDPE as used in the current invention can take place in either a tubular reactor or an autoclave reactor both of which are well known in the art.

Without wishing to be bound by theory, the following general differences between polyethylene made in an autoclave reactor and a polyethylene made in a tubular reactor are discussed. Due to the broad residence time distributions, polyethylene made in an autoclave reactor typically has a larger proportion of high molecular weight polymer and long chain branching relative to polyethylene made using a tubular reactor, where residence time distributions are comparably narrower. As a consequence, autoclave HPLDPE generally has superior neck-in properties. In contrast, tubular reactors provide HPLDPE with good adhesion properties due in part to a higher proportion of low molecular weight polymer.

The gas permeable, non-perforated polyethylene films of the current invention are used to make produce packages, preferably fresh cut produce packages.

In an aspect of the invention, the gas permeable, non perforated polyethylene film is made from a polymer blend of (a) 95-60 wt % LLDPE having a density of from 0.905 to 0.920 g/cc and (b) 5 to 40 wt % HPLDE having a melt index, I₂, of from 0.15 to 2.0 g/10 min.

In another aspect of the invention, the gas permeable, non perforated polyethylene film is made from a polymer blend of (a) 95-70 wt % LLDPE having a density of from 0.905 to 0.920 g/cc and a melt index of from 0.5 to 2.0 g/10 min; and (b) 5 to 30 wt % HPLDPE having a melt index, I₂, of from 0.15 to 2.0 g/10 min and a density of from 0.916 to 0.924 g/cc.

In another aspect of the invention, the gas permeable, non perforated polyethylene film is made from a polymer blend of (a) 95-70 wt % LLDPE having a density of from 0.905 to 0.920 g/cc and a melt index, I₂, of from 0.5 to 2.0 g/10 min; and (b) 5 to 30 wt % HPLDPE having a melt index, I₂, below 1.0 g/10 min and a density of from 0.916 to 0.924 g/cc.

In one aspect of the current invention, the gas permeable, non perforated polyethylene film is made from a polymer blend of (a) 95-60 wt % LLDPE which is a heterogeneously branched polyethylene having a density greater than 0.916 g/cc, a molecular weight distribution, Mw/Mn, of less than 4.0 and a melt index, I₂, of from 0.5 to 2.0 g/10 min; and (b) 5 to 40 wt % HPLDPE having a melt index, I₂, of from 0.15 to 2.0 g/10 min and a density of from 0.916 to 0.924 g/cc.

In another aspect of the invention, the sealed produce package is made from a gas permeable, non-perforated film which has an absolute oxygen transmission rate which is greater than the weighted average of the absolute oxygen transmission rates of film prepared from each blend component.

In an aspect of the invention, the gas permeable, non-perforated films will have an absolute oxygen transmission rate of at least 550 ccO2 at 1 mil/100 in2.24 hrs and the densities of the linear low density polyethylene and the high pressure low density polyethylene used as blend components will be above 0.910 g/cc.

In an aspect of the invention, the gas permeable, non-perforated films will have a normalized OTR that increases as the drawdown ratio (DDR) is increased. In the present invention, the drawdown ratio (DDR) is defined as the ratio of the die gap to the product of final film thickness and the blow up ratio (BUR) on a blown film line; i.e., DDR=die gap/final film thickness×blow up ratio. A person skilled in the art will recognize that the drawdown ratio may be increased by increasing the die gap, or by decreasing the final film thickness or blow up ratio.

In another aspect of the invention, the gas permeable, not perforated films will have a normalized OTR that increases as the film thickness decreases. In a particular embodiment, the normalized OTR will increase as the film thickness decreases for film of 1 mil or less in thickness.

Without wishing to be bound by theory, the density of the polymer blend will be at least similar to the weighted average of the densities of the blend components. Hence, in another aspect of the invention, the gas permeable, non-perforated films will have an absolute oxygen transmission rate of at least 550 ccO2 at 1 mil/100 in2.24 hrs and the density of the polymer blend from which the film is made will be at least 0.910 g/cc.

The gas permeable, non perforated polyethylene film used in the current invention will have a thickness of from 0.1 to 2 mil, preferably a thickness of 1.5 mil or less.

The above description applies to the preparation of monolayer films. However, multilayer films may also be prepared and used to prepare the sealed produce packages of the current invention.

Multilayer films can be made using a co-extrusion process or a lamination process. In co-extrusion, a plurality of molten polymer streams are fed to an annular die (or flat cast) resulting in a multi-layered film on cooling. In lamination, a plurality of films are bonded together using, for example, adhesives, joining with heat and pressure and the like. A multilayer film structure may, for example, contain tie layers and/or sealant layers.

The film used in the current invention may be a skin layer or a core layer and can be used in at least one or a plurality of layers in a multilayer film.

The term “core” or the phrase “core layer”, refers to any internal film layer in a multilayer film. The phrase “skin layer” refers to an outermost layer of a multilayer film in packaging produce. The phrase “sealant layer” refers to a film that is involved in the sealing of the film to itself or to another layer in a multilayer film. A “tie layer” refers to any internal layer that adheres two layers to one another.

In addition to the gas permeable, non-perforated polyethylene film layer, the multilayer film can contain one or more than one polyolefin layer. As used herein, the term “polyolefin” refers to any polymerized or copolymerized olefin or olefins which can be linear, branched, cyclic, aliphatic, aromatic, substituted, including heteroatom substituted or unsubstituted and to blends or mixtures of such polymerized or copolymerized olefin or olefins.

In an aspect of the invention, the polyolefin will be selected from the group consisting of polyethylene, including ethylene copolymers and ethylene homopolymers such as but not limited to HPLDPE, LLDPE, ethylene plastomers and very low density polyethylene (VLDPE), and ethylene vinyl acetate; polypropylene, including propylene copolymers and homopolymers; ethylene/propylene copolymers; and blends thereof with other polyolefins.

A wide range of suitable polyolefins are contemplated so long as they are compatible with the gas permeable, non perforated polyethylene film used in the current invention in the formation of a multilayer film.

The polyolefins may be perforated or non-perforated or they may contain inorganic fillers. The polyolefins may also contain additives to impart to or enhance certain properties of the film, and these additives include fillers, antioxidants, antifogging agents (such as those taught in U.S. Pat. Nos. 4,835,194 and 4,486,522, plasticizers, tackifiers, etc.

In an aspect of the invention, the multilayer film will be composed of i) one or more than one layer of a gas permeable, non-perforated polyethylene film prepared from a polymer blend comprising (a) 95-70 wt % of a linear low density polyethylene having a density of from 0.905 to 0.920 g/cc and a melt index, I₂, of from 0.5 to 2.0 g/10 min; and (b) 5 to 30 wt % of a high pressure low density polyethylene having a melt index, I₂, of from 0.15 to 2.0 g/10 min and a density of from 0.916 to 0.924 g/cc; and optionally contains ii) one or more than one polyolefin film layer.

The thickness of the multilayer films can be from about 0.5 mil to about 10 mil total thickness.

Preferably the gas permeable, non-perforated polyethylene film used in the current invention will be 1 mil or less than 1 mil in thickness when used as a film layer in a multilayer film.

Monolayer or multilayer polymer films of the current invention may be oriented to impart improved properties. By “oriented”, it is meant that the film has been stretched at an elevated temperature, followed by setting the stretched configuration by cooling. Oriented polyethylene film is typically made using a double bubble process, a process well known in the art or by use of machine direction orientors (MDOs).

The gas permeable, non-perforated polyethylene films described in the current invention are for use in sealed packages that contain respiring food stuffs. Preferably, the packages are used for respirating (i.e., fresh) produce, such as fresh cut vegetables including carrots, broccoli, spinach, lettuce, cauliflower, and mixtures thereof, and fruits such as blueberries, raspberries, cranberries, blackberries, strawberries, avocadoes, melons and the like.

The gas permeable, non-perforated polyethylene film described in the current invention, including multilayer films containing the film described in the current invention, can be made into packaging structures such as form-fill-seal structures (vertical or horizontal) and thermoform-fill-seal structures (see, for example: “Packaging, Flexible” by Jeffrey J. Wooster, Published online: 22 Oct. 2001 in Encyclopedia Of Polymer Science and Technology, pg 353, © 2002 by John Wiley & Sons, Inc. Last updated: 19 Sep. 2006).

The gas permeable, non-perforated polyethylene film described in the current invention is suitable for use in any type of package which contains respirating produce, especially produce requiring respiration rates in excess of least 550 ccO2 mil/100 in2.24 hrs to avoid spoilage.

The gas permeable, non-perforated polyethylene films used in the current invention are further described by the following non limiting examples.

### EXAMPLES

The melt index, I₂, was determined in accordance with ASTM D1238 (at 190° C., using a 2.16 kg weight). The test results are reported in grams/10 minutes.

The polymer blend formulations are described in terms of each blend component weight percent used to prepare them.

The densities were determined according to ASTM D792 and are given in grams per cc.

Mn, Mw and Mz (g/mol) were determined by Gel Permeation Chromatography and measured in accordance with ASTM D6474-99.

The oxygen transmission rate (OTR) was determined substantially in accordance with ASTM D3985-81 under standard conditions of 1 atmosphere and a temperature of 23° C. Side 1 of the barrier had 100% oxygen while side 2 of barrier had 0% oxygen and 0% relative humidity (1 atm driving force).

The moisture vapor transmission rate (“MVTR” as expressed as grams of water vapor transmitted per 100 square inches of film per day at a specified film thickness (mils), or g/100 in2/day) was determined according to ASTM F1249-90 with a MOCON permatron developed by Modern Controls Inc. The temperature was 23° C. Side 1 of the barrier of barrier had 100% relative humidity while side 2 of had 0% relative humidity.

All experiments were run on a commercial scale blown film line manufactured by the Macro Engineering Company. The line was fitted with an 8″ diameter (about 25.1″ circumference) spiral die, a 3.5″ single screw extruder with barrier design and a length/diameter ratio of 30/1. Two film die gaps were run: 35 mil and 100 mils. The cooling unit consisted of a dual lip air ring in combination with internal bubble cooling. All films were prepared using a blow up ratio, BUR of 2.5/1. Film having several different gauges was made (0.6, 1.0, 1.5 and 2.0 mil films were made). The frost line height was not fixed but was relatively similar for all film samples.

The drawdown ratio (DDR) is defined as the ratio of the die gap to the product of final film thickness and the blow up ratio, BUR; i.e., DDR=die gap/final film thickness×blow up ratio. All films were prepared at a BUR of 2.5.

The polyethylene resins used in the examples are described below and in Table 1.

Polymer A is a homogeneously branched linear low density polyethylene (i.e., an ethylene/1-octene copolymer) which was prepared in a dual reactor solution polymerization process as generally described in U.S. Patent Application Publication No. 2004/0086671.

Polymer B and C are heterogeneously branched linear low density polyethylenes (i.e., ethylene/1-octene copolymers) which were prepared in a solution process using a conventional Ziegler-Natta type catalyst.

Polymers D, E, F and G are high pressure low density polymers prepared in a high pressure tubular reactor.

| | Melt Index, I₂ | Density | CDBI |
|---|---|---|---|
| Polymer | (grams/10 minutes) | (g/cc) | (%) |
| A | 1 | 0.918 | >50 |
| B | 1 | 0.920 | <50 |
| C | 0.9 | 0.912 | <50 |
| D | 2 | 0.919 | — |
| E | 0.8 | 0.919 | — |
| F | 0.25 | 0.920 | — |
| G | 2 | 0.922 | — |

Films containing 100% LLDPE and 100% HPLDPE were made and the OTR data is provided in Table 2a (for LLDPE) and Table 2b (for HPLDPE).

Films made from polyethylene blends containing 90% LLDPE/10% LDPE, and 80% LLDPE/LDPE were made and the OTR data is provided in Table 3-5.

The oxygen transmission rates in Tables 2-5 are reported as ccO2/100 in2.24 hrs per film gauge measured (i.e., the OTR values have not been normalized). The OTR taken for a film gauge of 1 mil is equal to the absolute oxygen transmission rate.

TABLE 2a
(LLDPEs)

| | Polymer A | | | | Polymer B | | Polymer C | |
|---|---|---|---|---|---|---|---|---|
| Film Gauge | (35 mil die gap) | | (100 mil die gap) | | (35 mil die gap) | | (100 mil die gap) | |
| (mil) | MVTR | OTR | MVTR | OTR | MVTR | OTR | MVTR | OTR |
| 0.6 | 2.583 | 1144.2 | 2.403 | 1110.7 | 1.9706 | 1076.6 | 3.888 | 1425.1 |
| 1 | 1.677 | 644 | 1.533 | 682.2 | 1.2776 | 703.4 | 1.966 | 811.6 |
| 2 | 0.8023 | 300.4 | 0.6854 | 338.7 | 0.6152 | 319.4 | 0.9835 | 426.1 |

TABLE 2b
(HPLDPEs)

| | |
|---|---|
| Polymer D | Polymer E |
| (35 mil die gap) | (35 mil die gap) |

| Film Gauge (mil) | MVTR | OTR | MVTR | OTR |
|---|---|---|---|---|
| 0.6 | 3.919 | 1566 | — | — |
| 1.0 | 2.274 | 814.6 | 2.646 | 862.8 |
| 2.0 | 0.9308 | 325.2 | 0.9979 | 351.6 |

TABLE 3

| | |
|---|---|
| (35 mil die gap) | (100 mil die gap) |

| | | | | |
|---|---|---|---|---|
| Film Gauge (mil) | MVTR | OTR | MVTR | OTR |

90% Polymer A/10% Polymer D

| | | | | |
|---|---|---|---|---|
| 0.6 | 3.578 | 1451.8 | 3.585 | 1765 |
| 1.0 | 1.39 | 699.7 | 1.616 | 747.4 |
| 2.0 | 0.6266 | 324.7 | 0.6724 | 331.3 |

80% Polymer A/20% Polymer D

| | | | | |
|---|---|---|---|---|
| 0.6 | 3.286 | 1681 | 3.627 | 1600.5 |
| 1.0 | 1.534 | 792.7 | 1.831 | 840.7 |
| 2.0 | 0.6109 | 306 | 0.6383 | 294.2 |

90% Polymer A/10% Polymer E

| | | | | |
|---|---|---|---|---|
| 0.6 | 3.077 | 1598.5 | 3.105 | 1651.7 |
| 1.0 | 1.349 | 726.4 | 1.981 | 686.7 |
| 2.0 | 0.6361 | 332.3 | 0.665 | 293.3 |

80% Polymer A/20% Polymer E

| | | | | |
|---|---|---|---|---|
| 0.6 | 2.994 | 1705.2 | 3.52 | 2073.6 |
| 1.0 | 1.5407 | 816.6 | 1.96 | 987.2 |
| 2.0 | 0.6324 | 327.5 | 0.7114 | 347.7 |

TABLE 4

| | 90% Polymer B/ | | 80% Polymer B/ | | 90% Polymer B/ | | 80% Polymer B/ | |
|---|---|---|---|---|---|---|---|---|
| | 10% Polymer D | | 20% Polymer D | | 10% Polymer E | | 20% Polymer E | |
| | Die Gap | | | | | | | |
| | (35 mil die gap) | | (35 mil die gap) | | (35 mil die gap) | | (35 mil die gap) | |
| Film Gauge (mil) | MVTR | OTR | MVTR | OTR | MVTR | OTR | MVTR | OTR |
| 0.6 | 2.678 | 1315.7 | 3.527 | 1515.8 | 2.971 | 1460.5 | 3.656 | 1581.2 |
| 1 | 1.18 | 593.9 | 1.269 | 681.3 | 1.3933 | 670.3 | 1.7372 | 729.8 |
| 2 | 0.5707 | 294.2 | 0.5565 | 268.8 | 0.6687 | 289.9 | 0.6526 | 274.2 |

TABLE 5

| | 90% Polymer C/ | | 80% Polymer C/ | | 90% Polymer C/ | | 80% Polymer C/ | |
|---|---|---|---|---|---|---|---|---|
| | 10% Polymer D | | 20% Polymer D | | 10% Polymer E | | 20% Polymer E | |
| | Density (g/cc) | | | | | | | |
| | 0.912 | | 0.913 | | 0.911 | | 0.913 | |
| | Die gap (mil) | | | | | | | |
| | 100 | | 100 | | 100 | | 100 | |
| Film Gauge (mil) | MVTR | OTR | MVTR | OTR | MVTR | OTR | MVTR | OTR |
| 0.6 | 4.435 | 2265.7 | 3.422 | 1904.6 | 3.888 | 1932.8 | 4.015 | 1949.7 |
| 1 | 2.242 | 909 | 2.238 | 917.3 | 1.994 | 987.4 | 2.537 | 1046.3 |
| 2 | 0.8841 | 363.7 | 0.8519 | 350.4 | 0.9086 | 359 | 0.8926 | 358 |

The data provided in Tables 2-5, show that films made from blends of polymers A-E (each of which has a density above 0.910 g/cc) have oxygen transmission rates of more than 550 ccO2/100 in².24 hrs at 1 mil of film thickness. In some cases, especially for blends of HPLDPE with polymer C, an OTR of at least 900 ccO₂/100 in².24 hrs at 1 mil of film thickness was obtained.

Significantly, all the films made from the above polyethylene blends have an absolute oxygen transmission rate that is higher than the weighted average of the absolute oxygen transmission rate of film made from each blend component.

For example, the weighted average OTR of a 1 mil film composed of 80% Polymer A (OTR=644 ccO₂/100 in².24 hrs) and 20% Polymer D (OTR=814.6 ccO₂/100 in².24 hrs) is expected to have an OTR=664 (0.80)+814.6 (0.20)=694 ccO₂ at 1 mil/100 in².24 hrs based on the weighted average rule. However, an OTR of 792.7 ccO₂ at 1 mil/100 in².24 hrs is observed.

In addition, the above data show that for films made from the blends of the present invention, higher drawdown ratios generally lead to higher normalized oxygen transmission rates (i.e., normalized OTR=OTR×film thickness). For example, the normalized OTR of a 1 mil film composed of 80% polymer A and 20% of polymer D, is 840.7 ccO₂.mil/100 in².24 hrs at a die gap of 100 (i.e., at a DDR of 40), and is 792.7 ccO₂.mil/100 in².24 hrs at a die gap of 35 (i.e., at a DDR of 14). Alternatively, the normalized OTR of a 0.6 mil film composed of 80% polymer A and 20% of polymer D, is 1008.6 ccO₂.mil/100 in².24 hrs at a die gap of 35 (i.e., at a DDR of 23.33), and the normalized OTR of a 2 mil film composed of 80% polymer A and 20% of polymer D, is 612 ccO₂.mil/100 in².24 hrs at a die gap of 35 (i.e. at a DDR of 7).

A person skilled in the art will recognize that similar data can be generated for other blends at different die gaps and different film gauges and that the normalized OTR generally increases as the drawdown ratio (DDR) is increased (i.e., by increasing the die gap or by decreasing the film gauge at a constant blow up ratio).

For clarity, the effect of the DDR on the normalized OTR is summarized in Table 6, for blends of A with D, and for blends of A with E. The blow up ratio, BUR is 2.5.

TABLE 6

| | Die | | | |
|---|---|---|---|---|
| Film | Gap | Film Gauge | Normalized | |
| Composition | (mil) | (mil) | OTR | DDR |
| 100% A | 35 | 0.6 | 686.5 | 23.33 |
| 100% A | 35 | 1 | 644 | 14 |
| 100% A | 35 | 2 | 600.8 | 7 |
| 90% A/10% D | 35 | 0.6 | 871.1 | 23.33 |
| 90% A/10% D | 35 | 1 | 699.7 | 14 |
| 90% A/10% D | 35 | 2 | 649.4 | 7 |
| 80% A/20% D | 35 | 0.6 | 1008.6 | 23.33 |
| 80% A/20% D | 35 | 1 | 792.7 | 14 |
| 80% A/20% D | 35 | 2 | 612 | 7 |
| 90% A/10% E | 35 | 0.6 | 959.1 | 23.33 |
| 90% A/10% E | 35 | 1 | 726.4 | 14 |
| 90% A/10% E | 35 | 2 | 664.6 | 7 |
| 80% A/20% E | 35 | 0.6 | 1023.1 | 23.33 |
| 80% A/20% E | 35 | 1 | 816.6 | 14 |
| 80% A/20% E | 35 | 2 | 655 | 7 |
| 100% A | 100 | 0.6 | 666.4 | 66.67 |
| 100% A | 100 | 1 | 682.2 | 40 |
| 100% A | 100 | 2 | 677.4 | 20 |
| 90% A/10% D | 100 | 0.6 | 1059 | 66.67 |
| 90% A/10% D | 100 | 1 | 747.4 | 40 |
| 90% A/10% D | 100 | 2 | 662.6 | 20 |
| 80% A/20% D | 100 | 0.6 | 960.3 | 66.67 |
| 80% A/20% D | 100 | 1 | 840.7 | 40 |
| 80% A/20% D | 100 | 2 | 588.4 | 20 |
| 90% A/10% E | 100 | 0.6 | 991.0 | 66.67 |
| 90% A/10% E | 100 | 1 | 686.7 | 40 |
| 90% A/10% E | 100 | 2 | 586.6 | 20 |
| 80% A/20% E | 100 | 0.6 | 1244.2 | 66.67 |
| 80% A/20% E | 100 | 1 | 987.2 | 40 |
| 80% A/20% E | 100 | 2 | 695.4 | 20 |

In a separate set of experiment runs from those discussed above, the OTR values for film made from polymers A, B and C were compared with film made from blends of each LLDPE polymer (A, B and C) with HPLDPE polymers E and F. The data is provided below in table 7. The oxygen transmission rates in Table 7 are reported as ccO₂/100 in².24 hrs per film gauge measured (i.e., the OTR values have not been normalized) as well as ccO₂/100 in².24 hrs per mil film gauge (i.e., the OTR values have been normalized). As discussed above, the OTR taken for a film gauge of 1 mil is equal to the absolute oxygen transmission rate.

TABLE 7

| | Film Gauge | | Normalized |
|---|---|---|---|
| Film composition | (mil) | OTR | OTR |
| 100% B | 2 | 314.9 | 629.8 |
| 100% B | 1 | 594.4 | 594.4 |
| 100% B | 0.6 | 1110.3 | 666.18 |
| 80% B + 20% F | 2 | 318.9 | 637.8 |
| 80% B + 20% F | 1 | 900.2 | 900.2 |
| 80% B + 20% F | 0.6 | 1572.2 | 943.32 |
| 90% B + 10% F | 2 | 228.9 | 457.8 |
| 90% B + 10% F | 1 | 850.6 | 850.6 |
| 90% B + 10% F | 0.6 | 1560.8 | 936.48 |
| 80% B + 20% G | 2 | 263 | 526 |
| 80% B + 20% G | 1 | 760.3 | 760.3 |
| 80% B + 20% G | 0.6 | 1484.2 | 890.52 |
| 100% C | 2 | 453.4 | 906.8 |
| 100% C | 1 | 798.7 | 798.7 |
| 100% C | 0.6 | 1917.8 | 1150.7 |
| 80% C + 20% F | 2 | 392.8 | 785.6 |
| 80% C + 20% F | 1 | 975.7 | 975.7 |
| 80% C + 20% F | 0.6 | 1744 | 1046.4 |
| 100% A | 2 | 294.6 | 618.7 |
| 100% A | 1 | 625.9 | 625.9 |
| 100% A | 0.6 | 889.7 | 622.8 |
| 80% A + 20% F | 2 | 311.2 | 622.4 |
| 80% A + 20% F | 1 | 862.1 | 862.1 |
| 80% A + 20% F | 0.6 | 1536.7 | 922.02 |
| 80% A + 20% G | 2 | 296.9 | 593.8 |
| 80% A + 20% G | 1 | 672.8 | 672.8 |
| 80% A + 20% G | 0.6 | 1468.3 | 880.98 |

The above examples are merely illustrations of current invention. It will be recognized by the person skilled in the art, that variations and modifications are possible without diverging from the scope of the invention as described herein.

What is claimed is:

1. A sealed produce package, said package being made from a gas permeable, non-perforated polyethylene film, wherein said film is prepared from a polymer blend comprising:
(a) 95-70 wt % of a linear low density polyethylene having a density of from 0.905 to 0.920 g/cc; and
(b) 5 to 30 wt % of a high pressure low density polyethylene having a melt index, I₂, of from 0.15 to 2.0 g/10 min.

2. The sealed produce package according to claim 1, wherein said high pressure low density polyethylene has a density of from 0.916 to 0.924 g/cc.

3. The sealed produce package according to claim 2, wherein said linear low density polyethylene has a melt index, I₂, of from 0.5 to 2.0 g/10 min.

4. The sealed produce package according to claim 3, wherein the melt index, I₂, of said high pressure low density polyethylene is less than 1.0 g/10 min.

5. The sealed produce package according to claim 4 wherein said gas permeable, non-perforated polyethylene film has a film thickness of 1 mil or less.

6. The sealed produce package according to claim 5, wherein the melt index, I₂, of said linear low density polyethylene is from 0.5 to 1.0 g/10 min.

7. The sealed produce package according to claim 1, wherein the linear low density polyethylene is a heterogeneously branched polyethylene having a density of greater than 0.916 g/cc and a molecular weight distribution, M_{w}/Mₙ, of less than 4.0.

8. The sealed produce package according to claim 1, wherein the density of the linear low density polyethylene is greater than 0.910 g/cc, the high pressure low density polyethylene has a density of greater than 0.910 g/cc, and said gas permeable, non-perforated polyethylene film has an absolute oxygen transmission rate of at least 550 ccO₂ at 1 mil/100 in².24 hrs.

9. The sealed produce package according to claim 1 wherein said gas permeable, non-perforated polyethylene film has an absolute oxygen transmission rate which is greater than a weighted average of,
the absolute oxygen transmission rate of a film prepared from said linear low density polyethylene, and
the absolute oxygen transmission rate of a film prepared from said high pressure low density polyethylene.

10. A sealed produce package, wherein said sealed produce package is made from a multilayer film comprising:
i) one or more layers of a gas permeable, non-perforated polyethylene film prepared from a polymer blend comprising:
(a) 95-70 wt % of a linear low density polyethylene having a density of from 0.905 to 0.920 g/cc, and a melt index, I₂, Of from 0.5 to 2.0 g/10 min; and
(b) 5 to 30 wt % of a high pressure low density polyethylene having a melt index, I₂, of from 0.15 to 2.0 g/10 min, and a density of from 0.916 to 0.924 g/cc; and
ii) one or more polyolefin film layers.

11. The sealed produce package of claim 10, wherein said polyolefin film layer is a film prepared from a polymer selected from the group consisting of polyethylene, polypropylene, ethylene/propylene copolymers and combinations thereof.

12. The sealed produce package of claim 11, wherein said polyolefin film layer is a microperforated polypropylene film layer.

13. The sealed produce package of claim 12, wherein said gas permeable, non-perforated polyethylene film has a thickness of less than 1 mil.

14. The sealed produce package according to claim 10, wherein the linear low density polyethylene is a heterogeneously branched polyethylene having a density of greater than 0.916 g/cc and a molecular weight distribution, M_{w}/Mₙ, of less than 4.0.

15. The sealed produce package according to claim 10, wherein the density of said linear low density polyethylene is greater than 0.910 g/cc, the density of said high pressure low density polyethylene is greater than 0.910 g/cc, and said gas permeable, non-perforated polyethylene film has an absolute oxygen transmission rate of at least 550 ccO₂ at 1 mil/100 in².24 hrs.

16. The sealed produce package according to claim 10 wherein said gas permeable, non-perforated polyethylene film has an absolute oxygen transmission rate which is greater than a weighted average of,
the absolute oxygen transmission rate of a film prepared from said linear low density polyethylene, and
the absolute oxygen transmission rate of a film prepared from said high pressure low density polyethylene.

17. A gas permeable, non-perforated polyethylene film for use in a sealed produce package, wherein said gas permeable, non-perforated polyethylene film is prepared from a polymer blend comprising:
(a) 95-70 wt % of a linear low density polyethylene having a density of from 0.905 to 0.920 g/cc; and
(b) 5 to 30 wt % of a high pressure low density polyethylene having a melt index, I₂, of from 0.15 to 2.0 g/10 min.

18. The gas permeable, non-perforated polyethylene film according to claim 17, wherein said high pressure low density polyethylene has a density of from 0.916 to 0.924 g/cc.

19. The gas permeable, non-perforated polyethylene film according to claim 18, wherein said linear low density polyethylene has a melt index, I₂, of from 0.5 to 2.0 g/10 min, and the melt index, I₂, of said high pressure low density polyethylene is less than 1.0 g/10 min.

20. The gas permeable, non-perforated polyethylene film according to claim 19 wherein the gas permeable, non-perforated polyethylene film has a film thickness of 1 mil or less.

21. The gas permeable, non-perforated polyethylene film according to claim 17, wherein the linear low density polyethylene is a heterogeneously branched polyethylene having a density of greater than 0.916 g/cc and a molecular weight distribution, M_{w}/Mₙ, of less than 4.0.

22. The gas permeable, non-perforated polyethylene film according to claim 17, wherein the density of said linear low density polyethylene is greater than 0.910 g/cc, said high pressure low density polyethylene has a density of greater than 0.910 g/cc, and said gas permeable, non-perforated polyethylene film has an absolute oxygen transmission rate of at least 550 ccO₂ at 1 mil/100 in².24 hrs.

23. The gas permeable, non-perforated polyethylene film according to claim 17, wherein said gas permeable, non-perforated polyethylene film has an absolute oxygen transmission rate which is greater than a weighted average of,
the absolute oxygen transmission rate of a film prepared from said linear low density polyethylene, and
the absolute oxygen transmission rate of a film prepared from said high pressure low density polyethylene.

24. A gas permeable, non-perforated polyethylene film prepared from a polymer blend comprising:
(a) 95-60 wt % of a linear low density heterogeneously branched polyethylene having a melt index, I₂, of from 0.5 to 2.0 g/10 min, a density of greater than 0.916 g/cc, and a molecular weight distribution, M_{w}/Mₙ, of less than 4.0; and
(b) 5 to 40 wt % of a high pressure low density polyethylene having a melt index, I₂, of from 0.15 to 2.0 g/10 min and a density of from 0.916 to 0.924 g/cc.

25. A gas permeable, non-perforated polyethylene film for use in a sealed produce package, wherein said gas permeable, non-perforated polyethylene film is prepared on a blown film line, said gas permeable, non-perforated polyethylene film comprising a blend comprising:
(a) 95-70 wt % of a linear low density polyethylene having a density of from 0.905 to 0.920 g/cc; and
(b) 5 to 30 wt % of a high pressure low density polyethylene having a melt index, I₂, of from 0.15 to 2.0 g/10 min;
wherein said blown film line has a drawdown ratio, and said non-perforated polyethylene film has a normalized OTR that increases as the drawdown ratio of said blown film line is increased.
